(19) United States
(12) Patent Application Publication
(10) Pub. No.: US 2024/0144303 A1
(43) Pub. Date: May 2, 2024

(54) OPTIMIZATION APPARATUS, OPTIMIZATION METHOD, AND NON-TRANSITORY COMPUTER READABLE MEDIUM STORING OPTIMIZATION PROGRAM

(71) Applicant: NEC Corporation, Tokyo (JP)

(72) Inventor: Shinji ITO, Tokyo (JP)

(73) Assignee: NEC Corporation, Tokyo (JP)

(21) Appl. No.: 18/544,856

(22) Filed: Dec. 19, 2023

Related U.S. Application Data
(63) Continuation of application No. 17/927,999, filed on Nov. 28, 2022.

(51) Int. Cl. G06Q 30/0201

(52) U.S. Cl. CPC G06Q 30/0201

(57) ABSTRACT

An optimization apparatus includes: a selection unit that selects, as a correction value, an element having a magnitude equal to or smaller than a predetermined value from among convex hulls of a policy set; an acquisition unit that acquires a result of execution of a second policy executed in a second round, the second round being a round a predetermined round before a first round for executing a first policy that is determined from among the policy set; a calculation unit that calculates an estimated value of a loss vector in the execution of the policy based on the result of the execution and the correction value selected in the second round; an update unit that updates a first probability distribution based on the estimated value; and a determination unit that determines a policy for a next round based on the updated first probability distribution.

This application is a Continuation of U.S. application Ser. No. 17/927,999 filed on Nov. 28, 2022, which is a National Stage Entry of PCT/JP2020/021356 filed on May 29, 2020, the contents of all of which are incorporated herein by reference, in their entirety.

### TECHNICAL FIELD

The present invention relates to an optimization apparatus, an optimization method, and an optimization program, and, in particular, to an optimization apparatus, an optimization method, and an optimization program that perform online linear optimization in a bandit problem with delayed rewards.

### BACKGROUND ART

A technique for selecting an appropriate policy from among policy candidates and sequentially optimizing the policy based on a reward (or loss) received by executing the policy is known. Examples of the above technique include optimization of product prices.

Non Patent Literature 1 discloses a technique related to an optimization algorithm for sequentially optimizing a policy based on the received reward.

### CITATION LIST

### Non Patent Literature

Non Patent Literature 1: N. Cesa-Bianchi, C. Gentile, and Y. Mansour, Nonstochastic bandits with composite anonymous feedback, Proceedings of Machine Learning Research vol. 75:1-23, 2018.

### SUMMARY OF INVENTION

### Technical Problem

In Non Patent Literature 1, there is a problem that the performance significantly deteriorates as a result of the delay in the timing at which the reward for the executed policy can be received, and thus there was room for improvement.

The present disclosure has been made to solve the above-described problem and an object thereof is to provide an optimization apparatus, an optimization method, and an optimization program for implementing highly accurate optimization even when there is a delay in the timing at which a reward for an executed policy can be received.

### Solution to Problem

An optimization apparatus according to a first example aspect of the present disclosure includes:
selection means for selecting, as a correction value, an element having a magnitude equal to or smaller than a predetermined value from among convex hulls of a policy set;
acquisition means for acquiring a result of execution of a second policy executed in a second round, the second round being a round a predetermined round before a first round for executing a first policy that is determined from among the policy set;
calculation means for calculating an estimated value of a loss vector in the execution of the policy based on the result of the execution and the correction value selected in the second round;
update means for updating a first probability distribution based on the estimated value; and
determination means for determining a policy for a next round based on the updated first probability distribution.

An optimization method according to a second example aspect of the present disclosure includes:
selecting, by a computer, as a correction value an element having a magnitude equal to or smaller than a predetermined value from among convex hulls of a policy set;
acquiring, by the computer, a result of execution of a second policy executed in a second round, the second round being a round a predetermined round before a first round for executing a first policy that is determined from among the policy set;
calculating, by the computer, an estimated value of a loss vector in the execution of the policy based on the result of the execution and the correction value selected in the second round;
updating, by the computer, a first probability distribution based on the estimated value; and
determining, by the computer, a policy for a next round based on the updated first probability distribution.

An optimization program according to a third example aspect of the present disclosure causes a computer to execute:
selection processing of selecting, as a correction value, an element having a magnitude equal to or smaller than a predetermined value from among convex hulls of a policy set;
acquisition processing of acquiring a result of execution of a second policy executed in a second round, the second round being a round a predetermined round before a first round for executing a first policy that is determined from among the policy set;
calculation processing of calculating an estimated value of a loss vector in the execution of the policy based on the result of the execution and the correction value selected in the second round;
update processing of updating a first probability distribution based on the estimated value; and
determination processing of determining a policy for a next round based on the updated first probability distribution.

### Advantageous Effects of Invention

According to the present invention, it is possible to provide an optimization apparatus, an optimization method, and an optimization program for implementing highly accurate optimization even when there is a delay in the timing at which a reward for an executed policy can be received.

### BRIEF DESCRIPTION OF DRAWINGS

FIG. 1 is a block diagram showing a configuration of an optimization apparatus according to a first example embodiment;

FIG. 2 is a flowchart showing a flow of an optimization method according to the first example embodiment;

FIG. 3 is a diagram for explaining the concept of a problem setting according to a second example embodiment;

FIG. 4 is a block diagram showing a configuration of an optimization apparatus according to the second example embodiment;

FIG. 5 is a flowchart showing a flow of an optimization method according to the second example embodiment;

FIG. 6 is a flowchart showing a flow of weight function update processing according to the second example embodiment; and

FIG. 7 is a block diagram showing a configuration of an optimization apparatus according to a third example embodiment.

### EXAMPLE EMBODIMENT

In order to make it easier to understand example embodiments of the present disclosure, outlines of the background art and the problems thereof will be described.

The problems faced in the actual optimization of policies include “a bandit problem,” “delayed rewards”, and “an enormous number of solution candidates”. Each of these problems will be described below.

In the actual optimization of policies, only some reward values are received in some cases (a bandit problem). Specifically, when a certain policy A is executed, a reward can be received as a result of the execution of the policy A. However, the amount of the reward to be received if a policy B is executed at the time of the execution of the policy A is unknown.

Further, in reality, when a policy is executed, a reward cannot be received immediately in some cases (delayed rewards). Specific examples of the above cases include a case in which an optimal medication regimen is determined in a clinical trial of a certain drug. When the certain drug is given to a patient, it may take some time for a result of the medication to appear. In this case, it is necessary to determine the next medication regimen without knowing the result of the previous medication regimen.

Further, the number of candidates for a policy becomes enormous when policies are determined in some cases (an enormous number of solution candidates). Specifically, a case in which a marketing channel is optimized for a user will be described. In a case in which direct mails are sent to users, a determination about which combination of users the direct mails are sent to corresponds to a policy. When there are 10 users as candidates, there may be 2¹⁰=1024 ways to send an advertisement. In a case like in the above case in which the number of candidates for the policy is enormous, it is desirable to perform optimization by using structural information (the relevance of feature values) such as the attributes of users.

Non Patent Literature 1 discloses a technique related to an optimization algorithm in a bandit problem with a policy set (i.e., a set of policies) having a structure, an enormous number of policy candidates, and delayed rewards. However, in Non Patent Literature 1, there is a problem that the performance significantly deteriorates as a result of a delay of the reward, the degree of the deterioration being in accordance with the magnitude of the delay, and thus there was room for improvement.

An object of the example embodiments of the present disclosure is to provide an optimization apparatus, an optimization method, and an optimization program for implementing highly accurate optimization in a bandit problem with a policy set having a structure, an enormous number of policy candidates, and delayed rewards.

The example embodiments according to the present disclosure will be described hereinafter in detail with reference to the drawings. The same or corresponding elements are denoted by the same reference symbols throughout the drawings, and redundant descriptions will be omitted as necessary for the clarification of the description.

### First Example Embodiment

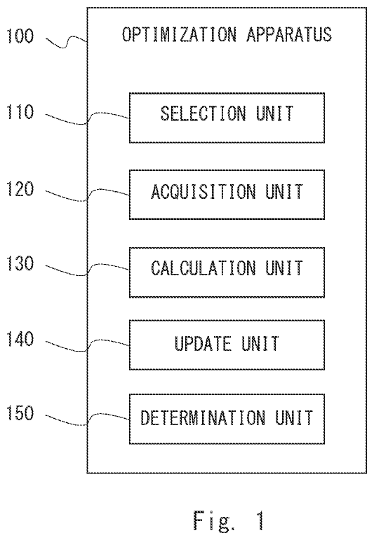

FIG. 1 is a block diagram showing a configuration of an optimization apparatus 100 according to a first example embodiment. The optimization apparatus 100 is an information processing apparatus that performs online linear optimization in a bandit problem with delayed rewards.

Note that the bandit problem is a problem in which a case where a content of an objective function changes each time a solution (an action, a policy) is executed by using the objective function, and only a value (a reward) of the objective function in a selected solution can be observed is set. Therefore, the online linear optimization in the bandit problem is online optimization in a case in which only some values of the objective function (the linear function) are obtained. Further, the term “delayed reward” means that even when a certain policy is executed in the t-th round, a reward for it is received (observed) in the t+d-th round (d is a delay). In other words, when t>d holds, the reward (the loss) acquired in the round t is a result of the execution of the policy in the round t−d.

The optimization apparatus 100 includes a selection unit 110, an acquisition unit 120, a calculation unit 130, an update unit 140, and a determination unit 150. The selection unit 110 selects, as a correction value, an element having a magnitude equal to or smaller than a predetermined value from among convex hulls of a policy set. Here, the “magnitude” may be referred to as a norm. The acquisition unit 120 acquires a result of execution of a second policy executed in a second round, the second round being a round a predetermined round before a first round for executing a first policy that is determined from among the policy set. Note that the predetermined round corresponds to a delay (a period of time, the number of rounds) in the feedback of a reward.

The calculation unit 130 calculates an estimated value of a loss vector in the execution of the policy based on the result of the execution and the correction value selected in the second round. Here, the loss vector is a factor vector or the like in the objective function using the policy as an argument. Note that the loss vector may be referred to as a reward vector. Further, the “correction value selected in the second round” is an element selected in the past (the second round) by the selection unit 110 described above.

The update unit 140 updates a first probability distribution based on the estimated value. The determination unit 150 determines a policy for a next round based on the updated first probability distribution.

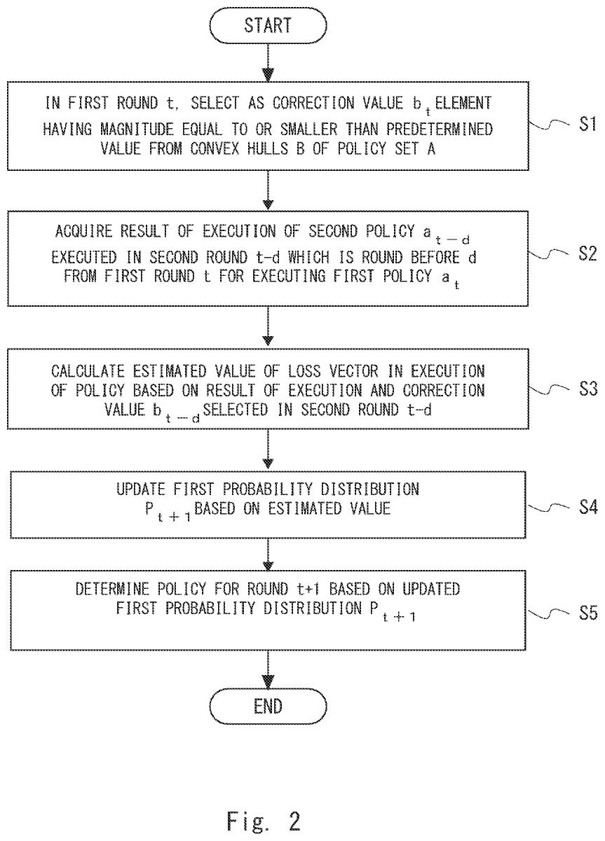

FIG. 2 is a flowchart showing a flow of an optimization method according to the first example embodiment. First, in a first round t, the selection unit 110 selects, as a correction value bₜ, an element having a magnitude equal to or smaller than a predetermined value from convex hulls B of a policy set A (S1). Next, the acquisition unit 120 acquires a result of execution of a second policy a_{t-d} a executed in a second round t−d which is a round before a predetermined round d from the first round t for executing a first policy aₜ (S2).

Then, the calculation unit 130 calculates an estimated value of a loss vector in the execution of the policy based on the result of the execution and the correction value b_{t-d} selected in the second round (S3). After that, the update unit 140 updates a first probability distribution Pₜ₊₁ based on the estimated value (S4).

Then, the determination unit 150 determines a policy for a round t+1 based on the updated first probability distribution Pₜ₊₁ (S5).

As described above, this example embodiment is intended for a case in which a result of execution (a reward, loss) for the policy a_{t-d} executed before the predetermined round d can be acquired in the round t for executing the policy aₜ. In other words, this example embodiment is intended for a case in which a result of execution (a reward, loss) for the policy aₜ executed in the round t can be acquired after the predetermined round d. Then, the estimated value of the loss vector that is used when the first probability distribution used to determine the policy is updated is calculated from the correction value b_{t-d} selected in the round t−d. At this time, the correction value b_{t-d} is a value selected from among the convex hulls B of the policy set A in the round t−d, and is a value having a magnitude equal to or smaller than a predetermined value. Consequently, since the correction value falls within a certain range, the estimated value is stabilized. Therefore, it is possible to update the first probability distribution in a stable manner and improve the accuracy of a policy to be determined. Accordingly, it is possible to implement highly accurate optimization even when there is a delay in the timing at which a reward for an executed policy can be received.

Note that the optimization apparatus 100 includes, as a configuration that is not shown, a processor, a memory, and a storage device. Further, a computer program in which processes of the optimization method according to this example embodiment are implemented is stored in the storage device. Further, the processor loads the computer program from the storage device into the memory and executes the loaded computer program. In this way, the processor implements the functions of the selection unit 110, the acquisition unit 120, the calculation unit 130, the update unit 140, and the determination unit 150.

Alternatively, each of the selection unit 110, the acquisition unit 120, the calculation unit 130, the update unit 140, and the determination unit 150 may be implemented by dedicated hardware. Further, some or all of the components of each apparatus may be implemented by a general-purpose or dedicated circuit (circuitry), a processor or the like, or a combination thereof. They may be formed of a single chip, or may be formed of a plurality of chips connected to each other through a bus. Some or all of the components of each apparatus may be implemented by a combination of the above-described circuit or the like and a program. Further, as the processor, a Central Processing Unit (CPU), a Graphics Processing Unit (GPU), a field-programmable gate array (FPGA) or the like may be used.

Further, when some or all of the components of the optimization apparatus 100 are implemented by a plurality of information processing apparatuses, circuits, or the like, the plurality of information processing apparatuses, the circuits, or the like may be disposed in one place in a centralized manner or arranged in a distributed manner. For example, the information processing apparatuses, the circuits, or the like may be implemented as a client-server system, a cloud computing system, or the like, or a configuration in which the apparatuses or the like are connected to each other through a communication network. Alternatively, the functions of the optimization apparatus 100 may be provided in the form of Software as a Service (SaaS).

### Second Example Embodiment

A second example embodiment is a specific example of the first example embodiment described above. It is assumed that the following Expression 1 is a set (a policy set) of a plurality of actions (policies) that can be executed in a predetermined environment (objective function), further, it is a set of m-dimensional feature vectors, and still further it is any subset of a vector space including a discrete set and a convex set.

[symbol]

⊆ [symbol] [Expression 1]

That is, the policy set is a set of multidimensional vectors. Further, it is assumed that the policy set has a structure and there are an enormous number of policy candidates. Still further, a policy aₜ is determined in each round t∈[T] of decision making and executed. Here, the objective function, that is, a reward (loss) associated with the policy aₜ is defined by the following Expression 2.

lₜ^{T}aₜ [Expression 2]

At this time, it is assumed that the following Expression 3 is a loss vector and the following Expression 4 is satisfied.

lₜ∈ [symbol] [Expression 3]

|lₜ^{T}a|≤1 [Expression 4]

Further, since the reward is delayed as described above, the reward to be acquired in a round t is expressed by the following Expression 5 when t>d holds.

l_{t-d}^{T}a_{t-d} ∈ [symbol] tm [Expression 5]

Further, the object of the optimization apparatus is to minimize a cumulative loss expressed by the following Expression 6.

$$\begin{matrix}[ Expression 6 ] & \\ {\sum }_{t = 1}^{T} {l}_{t}^{T} {a}_{t} & \end{matrix}$$

Further, the performance of the optimization apparatus is measured by regret R_{T} defined by the following equation (1).

$$\begin{matrix}[ Expression 7 ] & \\ {R}_{T} = {\sum }_{t = 1}^{T} {l}_{t}^{T} {a}_{t} - {min}_{{a}^{*} ∈ A} {\sum }_{t = 1}^{T} {l}_{t}^{T} {a}^{*} & ( 1 )\end{matrix}$$

where a* is a best fixed policy. Regarding the performance of the optimization apparatus, a smaller regret R_{T} is better than a larger one.

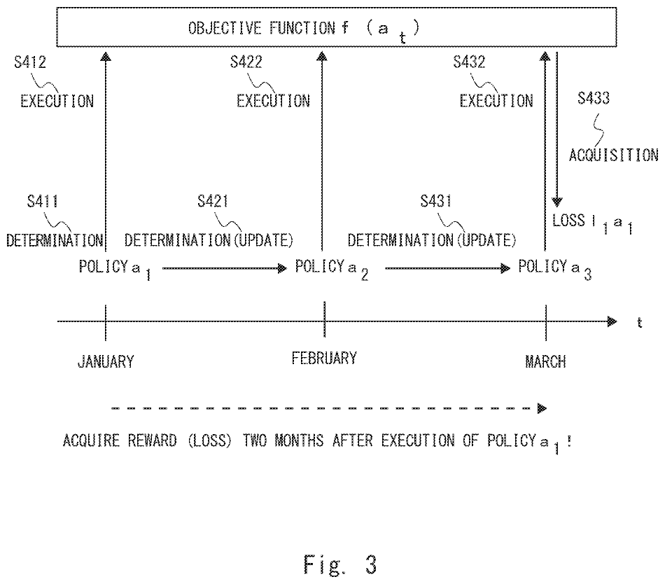

FIG. 3 is a diagram for explaining the concept of a problem setting according to the second example embodiment. For example, it is assumed that, for a certain objective function f(aₜ), the policy aₜ is determined each month and executed. Further, it is assumed that the acquisition of a result of the execution (a reward, loss) of the policy is delayed by two months. That is, it is assumed that the unit of the round t is one month, and a delay d=2. In this case, as shown in FIG. 3, a policy a₁ is determined in January (S411), and the determined policy a₁ is input to the objective function and then executed (S412). Similarly, a policy a₂ is determined in February (S421), and the determined policy a₂ is input to the objective function and then executed (S422). Further, a policy a₃ is determined in March (S431), and the determined policy a₃ is input to the objective function and then executed (S432). At this time, a loss l₁a₁, which is a result of the execution of the policy a₁ executed in January, is acquired two months later, that is, acquired in March (S433). Note that the acquisition of the loss l₁a₁ is not performed in accordance with the assumption that the policy a₃ has been executed.

Next, a distribution truncation according to this example embodiment will be described. First, the convex hull B in the policy set A is defined by the following Expression 8.

[symbol]

=conv( [symbol] )⊆ [symbol] [Expression 8]

Next, a probability distribution p on the convex hull B is given, and an expected value, which is expressed by the following Expression 9, variance S(p)∈Sym(m), and covariance Cov(p) E Sym(m) are defined by the following Expressions 10 to 12.

$$\begin{matrix}[ Expression 9 ] & \\ μ ( x ) ∈ {ℝ}^{m} & \end{matrix}$$

$$\begin{matrix}[ Expression 10 ] & \\ μ ( x ) := {E}_{x \sim p} [ x ] & \end{matrix}$$

$$\begin{matrix}[ Expression 11 ] & \\ S ( p ) := {E}_{x \sim p} [ {xx}^{T} ] & \end{matrix}$$

$$\begin{matrix}[ Expression 12 ] & \\ Cov ( p ) := {\sum }_{x ∼ p} [ ( x - μ ( p ) ) {( x - μ ( p ) )}^{T} ] & \end{matrix}$$

Further, the probability distribution p on the convex hull B is given, and a truncated distribution p′ is defined by the following equation (2).

$$\begin{matrix}[ Expression 13 ] & \\ {p}^{′} ( x ) = \frac{p ( x ) 1 \{ {‖ x ‖}_{{S ( p )}^{- 1}}^{2} \leq m {γ}^{2} \}}{{Prob}_{y \sim p} [ {‖ y ‖}_{{S ( p )}^{- 1}}^{2} \leq m {γ}^{2} ]} ∝ p ( x ) 1 \{ {‖ x ‖}_{{S ( p )}^{- 1}}^{2} \leq m {γ}^{2} \} & ( 2 )\end{matrix}$$

where a vector “1” has n element values, each of which is 1, m is the number of dimensions of each feature vector of the policy set A, and γ is a parameter of more than 4 log(mT). When p is a log-concave distribution, p and p′ can be approximated.

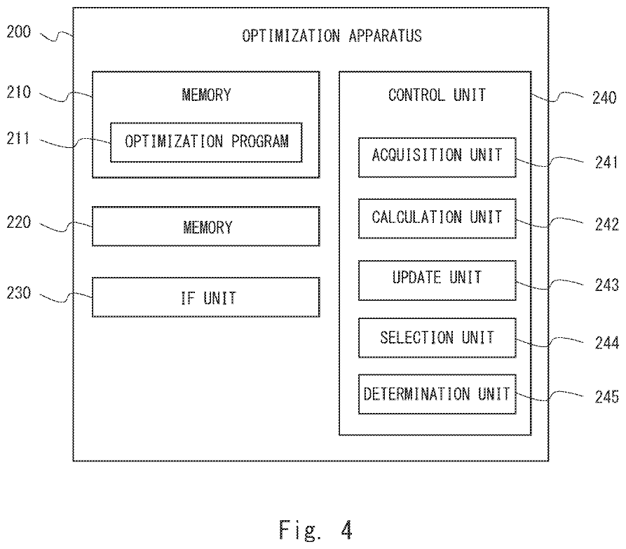

FIG. 4 is a block diagram showing a configuration of an optimization apparatus 200 according to the second example embodiment. The optimization apparatus 200 is an information processing apparatus which is a specific example of the optimization apparatus 100 described above. The optimization apparatus 200 includes a storage unit 210, a memory 220, an interface (IF) unit 230, and a control unit 240.

The storage unit 210 is a storage device such as a hard disk or a flash memory. The storage unit 210 stores at least an optimization program 211. The optimization program 211 is a computer program in which an optimization method according to this example embodiment is implemented.

The memory 220, which is a volatile storage device such as a Random Access Memory (RAM), is a storage area for temporarily holding information when the control unit 240 is operated. The IF unit 230 is an interface that receives/outputs data from/to the outside of the optimization apparatus 200. For example, the IF unit 230 receives input data from another computer or the like via a network (not shown), and outputs the received input data to the control unit 240. Further, in response to an instruction from the control unit 240, the IF unit 230 outputs data to a destination computer via a network. Alternatively, the IF unit 230 receives an operation performed by a user through an input device (not shown) such as a keyboard, a mouse, and a touch panel, and outputs the received operation content to the control unit 240. Further, in response to an instruction from the control unit 240, the IF unit 230 outputs data to a touch panel, a display apparatus, a printer, and the like (not shown).

The control unit 240 is a processor such as a Central Processing Unit (CPU), and controls each component of the optimization apparatus 200. The control unit 240 loads the optimization program 211 from the storage unit 210 into the memory 220, and executes the optimization program 211. In this way, the control unit 240 implements the functions of an acquisition unit 241, a calculation unit 242, an update unit 243, a selection unit 244, and a determination unit 245. Note that the acquisition unit 241, the calculation unit 242, the update unit 243, the selection unit 244, and the determination unit 245, respectively, are examples of the acquisition unit 120, the calculation unit 130, the update unit 140, the selection unit 110, and the determination unit 150 described above.

The selection unit 244 selects, as a correction value, a value having a norm equal to or smaller than a predetermined value from among the convex hulls of the policy set based on a second probability distribution in which a distribution larger than a predetermined value is excluded from the first probability distribution.

The determination unit 245 determines a first policy so that a correction value selected in a first round becomes the expected value.

When the first policy determined from among the policy set is executed in the first round, the acquisition unit 241 acquires a result of the execution of a second policy executed in a second round that is a round a predetermined round before the first round.

The calculation unit 242 calculates an estimated value of the loss vector in the execution of the policy based on the result of the execution, the correction value corresponding to the second round, and the variance of the second probability distribution in the second round.

The update unit 243 updates a weight function used to update the first probability distribution based on the estimated value. Then the update unit 243 updates the first probability distribution used to determine a policy for the next round by using the weight function.

The optimization method according to this example embodiment updates a distribution pₜ on the convex hull B:=conv(A) by a multiplicative weight update (MWU) method. Specifically, the following equations (3) and (4) are defined.

$$\begin{matrix}[ Expression 14 ] & \\ {w}_{t} ( x ) := exp ( - η {\sum }_{j = 1}^{t - d - 1} {\hat{l}}_{j}^{T} x ) & ( 3 )\end{matrix}$$

$$\begin{matrix}[ Expression 15 ] & \\ {p}_{t} ( x ) = \frac{{w}_{t} ( x )}{{\int }_{y ∈ B} {w}_{t} ( y ) dy} & ( 4 )\end{matrix}$$

where η is a parameter greater than zero and is a learning rate. Further, l\hat{ }ₜ is defined as follows.

[Expression 16]

\hat{l}ₜ=lₜ^{T}aₜS(p′ₜ)⁻¹bₜ (5)

where bₜ is a value (an element) selected from among the convex hulls B as described later.

Note that the details of each processing described above are included in the following description of the flowchart.

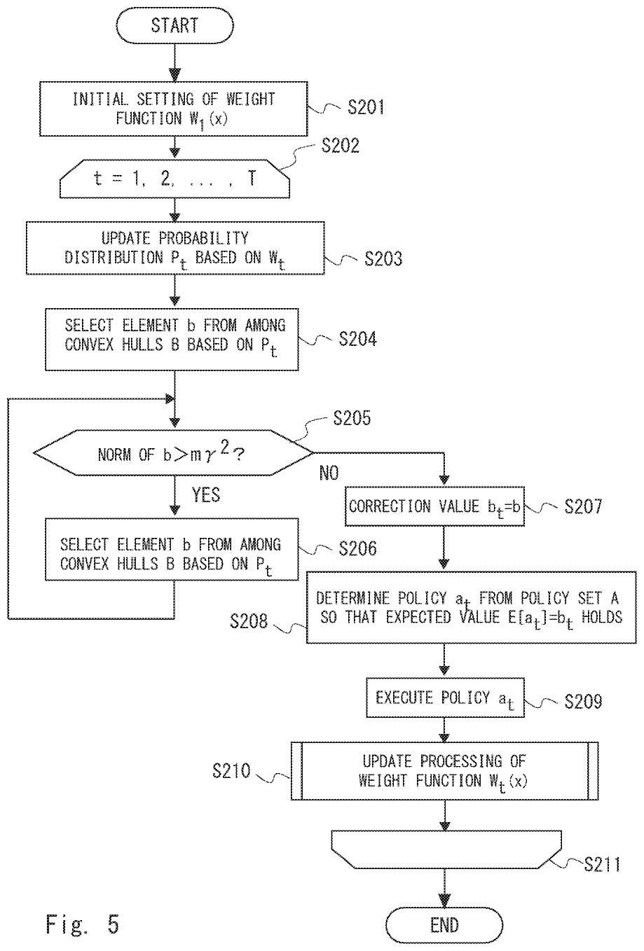

FIG. 5 is a flowchart showing a flow of the optimization method according to the second example embodiment. It is assumed here that A is a policy set and a parameter T is an upper limit value of the number of rounds. Then, it is assumed that the delay d of the reward≤T−1, γ≥4 log(mT), and η≤1/(100γ²(d+m)). Note that, it is assumed that these values are examples and can be freely set and changed by a user.

First, the control unit 240 performs an initial setting of a weight function w₁(x) (S201). It is assumed here that w₁(x)=1 for all x∈B, and the following Expression 17 holds.

w₁:B→ [symbol] [Expression 17]

Then, the control unit 240 adds t from the round t=1 to the round T one by one, and repeats the following Steps S203 to S211 (S202).

First, the update unit 243 updates a probability distribution pₜ based on wₜ (S203). Specifically, the update unit 243 calculates pₜ from the equation (4) using wₜ. Next, the selection unit 244 selects an element b from among the convex hulls B based on pₜ (S204). That is, the selection unit 244 selects b in accordance with the probability distribution pₜ.

Then, the control unit 240 determines whether or not the norm of b is larger than mγ² (S205). Specifically, the control unit 240 determines whether or not the following condition is satisfied.

∥b∥ₛ₍ₚ_{ₜ}₎_{^{−1}}²>mγ² [Expression 18]

Note that the norm of b is a Mahalanobis distance. When it is determined in Step S205 that the norm of b is larger than mγ², the selection unit 244 selects the element b from among the convex hulls B based on pₜ again (S206). After that, the control unit 240 performs Step S205 again.

When it is determined in Step S205 that the norm of b is mγ² or less, the determination unit 245 sets the selected b as the correction value bₜ in the round t (S207). Specifically, the determination unit 245 associates the round t with the correction value bₜ and holds them in the memory 220. Note that Steps S204 to S207 can be defined as processes for selecting a correction value from among the convex hulls of the policy set based on the truncated distribution (the second probability distribution).

At this time, the update unit 243 calculates the truncated distribution (the second probability distribution) p′ₜ in the round t using the equation (2), and associates the round t with the truncated distribution p′ₜ and holds them in the memory 220.

Then, the determination unit 245 determines the policy aₜ from the policy set A so that the expected value E[aₜ]=bₜ holds (S208).

After that, the control unit 240 executes the determined policy aₜ (S209).

Then, the control unit 240 performs update processing of the weight function wₜ(x) (S210).

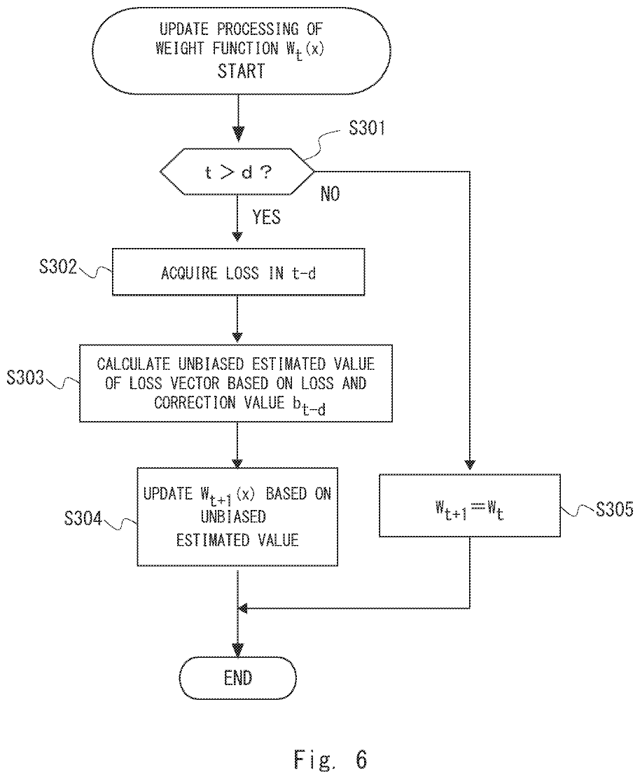

FIG. 6 is a flowchart showing a flow of the weight function update processing according to the second example embodiment. First, the control unit 240 determines whether or not the round t is greater than the delay d (S301). When t>d does not hold, that is, t≤d holds, the update unit 243 substitutes wₜ into wₜ₊₁ (S305).

On the other hand, when t>d holds, the acquisition unit 241 acquires the loss (the result of the execution) in the round t−d (S302). Here, the loss is, specifically, the following Expression 19.

l_{t-d}^{T}a_{t-d} [Expression 19]

Next, the calculation unit 242 calculates an unbiased estimated value l\hat{ }_{t-d} of the loss vector l_{t-d} in the round t−d based on the loss and the correction value b_{t-d} (S303). Specifically, the calculation unit 242 acquires the correction value b_{t-d} and the truncated distribution p′_{t-d} in the round t−d held in the memory 220. Then, the calculation unit 242 calculates the variance S(p′_{t-d}) of the truncated distribution p′_{t-d}. Then, the calculation unit 242 calculates, using the loss, the variance S(p′_{t-d}), and the correction value b_{t-d} acquired in Step 5302, the unbiased estimated value l\hat{ }_{t-d} by the following equation (6).

[Expression 20]

\hat{l}_{t-d}=l_{t-d}^{T}a_{t-d}S(p′_{t-d})⁻¹b_{t-d} (6)

Then, the update unit 243 updates wₜ₊₁(x) based on the unbiased estimated value l\hat{ }_{t-d} (S304). Specifically, the update unit 243 updates wₜ₊₁ (x) by the following equation (7).

[Expression 21]

wₜ₊₁(x)=wₜ(x)exp(−η\hat{l}_{t-d}^{T}x) (7)

After Step S304 or Step S305, when the round t is less than T, the process returns to Step S202 (S211).

Note that, in Non Patent Literature 1, the following regret has been achieved for online linear optimization in a bandit problem with delayed rewards.

[symbol]

(m\sqrt{dT}) [Expression 22]

However, in Non Patent Literature 1, since the unbiased estimated value l\hat{ }ₜ used to update the probability distribution pₜ is not limited, the probability distribution pₜ significantly varies from round to round. Therefore, in Non Patent Literature 1, there is a problem that the regret becomes worse.

In contrast, the present disclosure makes the unbiased estimated value l\hat{ }ₜ more stable by the following two techniques in order to make the MWU method work sufficiently uniformly regarding the problem setting of delayed feedback.

In the first technique, the convex hulls B of the policy set A:=conv(A) are taken into account and the distribution on B is used instead of A. That is, instead of selecting a policy directly from among the policy set A, an element is selected from among a convex set B, and then such a policy is selected that the expected value becomes the selected element. When the convex set B is applied to the MWU, the probability distribution pₜ has a property which is referred to as a log-concavity. Thus, it is possible to make the unbiased estimated value l\hat{ }ₜ more stable.

In the second technique, the distribution is truncated in order to ensure that the unbiased estimated value l\hat{ }ₜ is limited to within a predetermined value. Because of the property of the log-concavity, the element (the correction value) selected from among the convex set B falls within a predetermined value due to this truncation, and thus the correction value becomes stable. By calculating the unbiased estimated value l\hat{ }ₜ using the correction value that is stable between the rounds as described above, the unbiased estimated value l\hat{ }ₜ can be made stable.

According to the present disclosure, it is possible to achieve the following regret.

[symbol]

\sqrt{m(d+m)T}) [Expression 23]

Further, the regret is at least the following Expression 24 in the worst case.

[symbol]

\sqrt{m(d+m)T}) [Expression 24]

This lower bound indicates that the present disclosure is min-max optimal up to logarithmic factors.

As described above, in this example embodiment, it is possible to properly update the probability distribution pₜ for determining a policy by selecting a correction value from among the convex hulls of the policy set based on the truncated distribution. Therefore, it is possible to implement highly accurate optimization in a bandit problem with a policy set having a structure, an enormous number of policy candidates, and delayed rewards.

Next, examples according to the second example embodiment will be described.

### Example 2-1

In an example 2-1, it is assumed that a policy is a discount on the price of each company's beer at a certain store. For example, when the execution policy X=[0, 2, 1, . . . ] is set, the first element indicates that the beer price of a company A is the fixed price, the second element indicates that the beer price of a company B is 10% higher than the fixed price, and the third element indicates that the beer price of a company C is 10% discounted from the fixed price.

Then, the objective function uses, as input, the execution policy X, and every month, the sales are made at a price obtained by applying the execution policy X to the beer price of each company. Then, d months later, a result of the execution (a reward, a loss) of the policy X is output. In other words, in a month t when the execution policy Xₜ is executed, a result of the execution policy X_{t-d} executed d months ago is acquired. In this case, by applying the optimization method according to this example embodiment, it is possible to derive the optimal price setting for the beer price of each company at the store.

### Example 2-2

An example 2-2 describes a case where the optimization apparatus is applied to investment behavior of investors or the like. In this case, it is assumed that the execution policies are investment (purchasing, capital increase), sales, holding of a plurality of financial instruments (stocks or the like) held or to be held by investors. For example, when the execution policy X=[1, 0, 2, . . . ] is set, the first element indicates additional investment in the shares of a company A, the second element indicates holding the claims of a company B (not purchasing or selling), and the third element indicates sale of the shares of a company C. Then, the objective function uses, as input, the execution policy X and outputs the result of applying the execution policy X to investment behavior in each company's financial instruments. It is assumed here that a result of the execution of the execution policy Xₜ executed in the month t is acquired in a month t+d. In this case, by applying the optimization method according to this example embodiment, it is possible to derive the investors' optimal investment behavior in each stock.

### Example 2-3

An example 2-3 describes a case in which the optimization apparatus is applied to advertising behavior (a marketing policy) in an operating company of a certain electronic commerce site. In this case, it is assumed that an execution policy is an advertisement (an online (banner) advertisement, an e-mail advertisement, a direct mail, transmission of an e-mail having discount coupons attached thereto, etc.) to a plurality of customers for products or services which the operating company intends to sell. For example, when the execution policy X=[1, 0, 2, . . . ] is set, the first element indicates a banner advertisement for a customer A, the second element indicates no advertisement for a customer B, and the third element indicates transmission of an e-mail having discount coupons attached thereto to a customer C. Then, the objective function uses, as input, the execution policy X and outputs the result of applying the execution policy X to the advertising behavior for each customer. Note that the result of the execution may be whether or not the banner advertisement is clicked, the purchase amount, the purchase probability, or the expected value of the purchase amount. Further, it is assumed that a result of the execution of the execution policy Xₜ executed in the month t is acquired in a month t+d. In this case, by applying the optimization method according to this example embodiment, it is possible to derive optimal advertising behavior for each customer in the aforementioned operating company.

### Example 2-4

An example 2-4 describes a case in which the optimization apparatus is applied to medication behavior for a clinical trial of a certain drug in a pharmaceutical company. In this case, it is assumed that an execution policy is the amount of medication or the avoidance of medication. For example, when the execution policy X=[1, 0, 2, . . . ] is set, the first element indicates that the amount 1 of medication is given to a subject A, the second element indicates that no medication is given to a subject B, and the third element indicates that the amount 2 of medication is given to a subject C. Then, the objective function uses, as input, the execution policy X and outputs the result of applying the execution policy X to the medication behavior for each subject. It is assumed here that a result of the execution of the execution policy Xₜ executed in the month t is acquired in a month t+d. In this case, by applying the optimization method according to this example embodiment, it is possible to derive optimal medication behavior for each subject in the aforementioned clinical trial in the pharmaceutical company.

### Third Example Embodiment

A third example embodiment is a modified example of the second example embodiment described above.

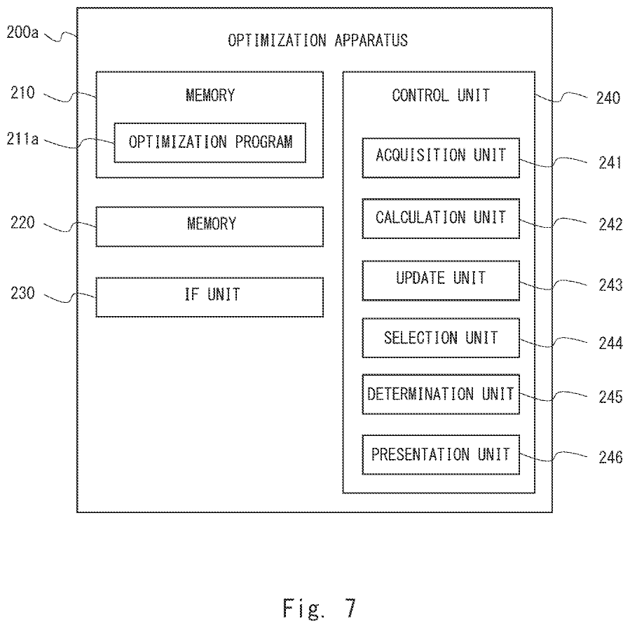

FIG. 7 is a block diagram showing a configuration of an optimization apparatus 200a according to the third example embodiment. In the optimization apparatus 200a, the optimization program 211 of the optimization apparatus 200 described above is replaced with an optimization program 211a and a presentation unit 246 is newly added. Configurations other than the above ones are similar to those of the optimization apparatus 200, and thus detailed descriptions thereof will be omitted.

The optimization program 211a is a computer program on which the optimization method according to this example embodiment is implemented.

The presentation unit 246 presents, after determination of the first policy, a parameter calculated for the determination to a user. For example, the presentation unit 246 outputs the parameter to a screen via the IF unit 230. Then, the acquisition unit 241 acquires the result of the execution of the second policy (before the d round) when the first policy is executed by the user. As described above, a user can determine the validity of the first policy by the presented parameter and then execute it. Thus, it is possible to promote the execution of the determined policy.

Further, the parameter may be at least either the estimated value or a weight function that is updated based on the estimated value and is used to update the first probability distribution. Note that the estimated value may be the unbiased estimated value described above.

As described above, according to this example embodiment, it is possible to properly update the probability distribution like in the second example embodiment and then present the reliability thereof to a user. Therefore, it is possible to promote the use of the optimization apparatus according to the present disclosure.

### Other Example Embodiments

Note that although the present disclosure has been described as a hardware configuration in the above example embodiments, the present disclosure is not limited thereto. In the present disclosure, any processing can also be implemented by causing a Central Processing Unit (CPU) to execute a computer program.

In the above-described examples, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (Read Only Memory), CD-R, CD-R/W, DVD (Digital Versatile Disc), and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Note that the present disclosure is not limited to the above-described example embodiments and may be changed as appropriate without departing from the spirit of the present disclosure. Further, the present disclosure may be executed by combining the example embodiments as appropriate.

The whole or part of the example embodiments disclosed above can be described as, but not limited to, the following supplementary notes.

### Supplementary Note 1

An optimization apparatus comprising:
selection means for selecting, as a correction value, an element having a magnitude equal to or smaller than a predetermined value from among convex hulls of a policy set;
acquisition means for acquiring a result of execution of a second policy executed in a second round, the second round being a round a predetermined round before a first round for executing a first policy that is determined from among the policy set;
calculation means for calculating an estimated value of a loss vector in the execution of the policy based on the result of the execution and the correction value selected in the second round;
update means for updating a first probability distribution based on the estimated value; and
determination means for determining a policy for a next round based on the updated first probability distribution.

### Supplementary Note 2

The optimization apparatus according to Supplementary note 1, wherein the selection means selects the correction value from among the convex hulls of the policy set based on a second probability distribution in which a distribution larger than the predetermined value is excluded from the first probability distribution.

### Supplementary Note 3

The optimization apparatus according to Supplementary note 2, wherein the calculation means calculates the estimated value by further using variance of the second probability distribution in the second round.

### Supplementary Note 4

The optimization apparatus according to any one of Supplementary notes 1 to 3, wherein the determination means determines the first policy so that the correction value selected in the first round becomes the expected value.

### Supplementary Note 5

The optimization apparatus according to any one of Supplementary notes 1 to 4, further comprising presentation means for presenting, after determination of the first policy, a parameter calculated for the determination to a user,
wherein the acquisition means acquires the result of the execution of the second policy when the first policy is executed by the user.

### Supplementary Note 6

The optimization apparatus according to Supplementary note 5, wherein the parameter is at least either the estimated value or a weight function that is updated based on the estimated value and is used to update the first probability distribution.

### Supplementary Note 7

The optimization apparatus according to any one of Supplementary notes 1 to 6, wherein the policy set is a set of marketing policies.

### Supplementary Note 8

The optimization apparatus according to any one of Supplementary notes 1 to 7, wherein the policy set are multidimensional vectors.

### Supplementary Note 9

An optimization method comprising:
selecting, by a computer, as a correction value an element having a magnitude equal to or smaller than a predetermined value from among convex hulls of a policy set;
acquiring, by the computer, a result of execution of a second policy executed in a second round, the second round being a round a predetermined round before a first round for executing a first policy that is determined from among the policy set;
calculating, by the computer, an estimated value of a loss vector in the execution of the policy based on the result of the execution and the correction value selected in the second round;
updating, by the computer, a first probability distribution based on the estimated value; and
determining, by the computer, a policy for a next round based on the updated first probability distribution.

### Supplementary Note 10

A non-transitory computer readable medium storing an optimization program for causing a computer to execute:
selection processing of selecting, as a correction value, an element having a magnitude equal to or smaller than a predetermined value from among convex hulls of a policy set;
acquisition processing of acquiring a result of execution of a second policy executed in a second round, the second round being a round a predetermined round before a first round for executing a first policy that is determined from among the policy set;
calculation processing of calculating an estimated value of a loss vector in the execution of the policy based on the result of the execution and the correction value selected in the second round;
update processing of updating a first probability distribution based on the estimated value; and
determination processing of determining a policy for a next round based on the updated first probability distribution.

Although the present invention has been described with reference to the example embodiments (and the examples), the present invention is not limited to the above-described example embodiments (and the examples). Various changes that may be understood by those skilled in the art may be made to the configurations and details of the present invention within the scope of the present invention.

### REFERENCE SIGNS LIST

100 OPTIMIZATION APPARATUS
110 SELECTION UNIT
120 ACQUISITION UNIT
130 CALCULATION UNIT
140 UPDATE UNIT
150 DETERMINATION UNIT
200 OPTIMIZATION APPARATUS
200a OPTIMIZATION APPARATUS
210 MEMORY
211 OPTIMIZATION PROGRAM
211a OPTIMIZATION PROGRAM
220 MEMORY
230 IF UNIT
240 CONTROL UNIT
241 ACQUISITION UNIT
242 CALCULATION UNIT
243 UPDATE UNIT
244 SELECTION UNIT
245 DETERMINATION UNIT
246 PRESENTATION UNIT

1. An optimization apparatus comprising:
at least one memory configured to store instructions; and
at least one processor configured to execute the instructions to:
select, as a correction value, an element having a magnitude equal to or smaller than a predetermined value from among convex hulls of a policy set;
acquire a result of execution of a second policy executed in a second round, the second round being a round a predetermined round before a first round for executing a first policy that is determined from among the policy set;
calculate an estimated value of a loss vector in the execution of the policy based on the result of the execution and the correction value selected in the second round;
update a first probability distribution based on the estimated value, wherein the first probability distribution is a probability distribution on the convex hulls; and
determine a policy for a next round based on the updated first probability distribution.

2. The optimization apparatus according to claim 1, wherein the at least one processor is further configured to execute the instructions to:
select the correction value from among the convex hulls of the policy set based on a second probability distribution in which a distribution larger than the predetermined value is excluded from the first probability distribution.

3. The optimization apparatus according to claim 2, wherein the at least one processor is further configured to execute the instructions to:
calculate the estimated value by further using variance of the second probability distribution in the second round.

4. The optimization apparatus according to claim 1, wherein the at least one processor is further configured to execute the instructions to:
determine the first policy so that the correction value selected in the first round becomes the expected value.

5. The optimization apparatus according to claim 1, wherein the at least one processor is further configured to execute the instructions to:
present, after determination of the first policy, a parameter calculated for the determination to a user, and acquire the result of the execution of the second policy when the first policy is executed by the user.

6. The optimization apparatus according to claim 5, wherein the parameter is at least either the estimated value or a weight function that is updated based on the estimated value and is used to update the first probability distribution.

7. The optimization apparatus according to claim 1, wherein the policy set is a set of marketing policies.

8. The optimization apparatus according to claim 1, wherein the policy set is a set of multidimensional vectors.

9. An optimization method comprising:
selecting, by a computer, as a correction value an element having a magnitude equal to or smaller than a predetermined value from among convex hulls of a policy set;
acquiring, by the computer, a result of execution of a second policy executed in a second round, the second round being a round a predetermined round before a first round for executing a first policy that is determined from among the policy set;
calculating, by the computer, an estimated value of a loss vector in the execution of the policy based on the result of the execution and the correction value selected in the second round;
updating, by the computer, a first probability distribution based on the estimated value, wherein the first probability distribution is a probability distribution on the convex hulls; and
determining, by the computer, a policy for a next round based on the updated first probability distribution.

10. A non-transitory computer readable medium storing an optimization program for causing a computer to execute:
selection processing of selecting, as a correction value, an element having a magnitude equal to or smaller than a predetermined value from among convex hulls of a policy set;
acquisition processing of acquiring a result of execution of a second policy executed in a second round, the second round being a round a predetermined round before a first round for executing a first policy that is determined from among the policy set;
calculation processing of calculating an estimated value of a loss vector in the execution of the policy based on the result of the execution and the correction value selected in the second round;
update processing of updating a first probability distribution based on the estimated value, wherein the first probability distribution is a probability distribution on the convex hulls; and
determination processing of determining a policy for a next round based on the updated first probability distribution.
